(19) United States
(12) Patent Application Publication
(10) Pub. No.: US 2017/0033497 A1
(43) Pub. Date: Feb. 2, 2017

(54) PLUG CONNECTOR HOUSING PROTECTED AGAINST CORROSION AND EROSION

(71) Applicant: INDUSTRIA LOMBARDA MATERIALE ELETTRICO I.L.M.E. S.P.A., Milano (IT)

(72) Inventor: Emilio GERMANI, Legnano (IT)

(21) Appl. No.: 15/215,927

(22) Filed: Jul. 21, 2016

(30) Foreign Application Priority Data
Jul. 29, 2015 (IT) 102015000039924

(51) Int. Cl. H01R 13/629; H01R 13/52; H01R 13/502

(52) U.S. Cl. CPC H01R 13/62955; H01R 13/5025; H01R 13/5219; H01R 13/5216

(57) ABSTRACT

Plug connector housing composed of two parts (1, 1′), each including a respective metal shell (2, 2′) preferably made of aluminium alloy, suitable for housing at least one respective contact element (3, 3′) connectable to a conductor of a cable, including at least one locking device (4) and at least one sealing gasket (6, 6′) of elastomeric material, the metal shell (2, 2′) including a protective coating resistant to corrosion and erosion (7) at least along its outer surface, wherein the protective coating resistant to corrosion and erosion (7) is constituted by at least one electrolytic ceramic coating (8).

### FIELD OF THE INVENTION

Subject of the present invention is a plug connector housing, protected against corrosion and erosion according to the preamble of independent claim 1.

### BACKGROUND OF THE INVENTION

In particular the invention relates to a plug connector housing with corrosion resistance and erosion resistance improved as compared to the types of the known art. Further characteristics of the invention described below are such as to confer to said electrical plug connector housing, in addition to improved corrosion resistance, high resistance to mechanical abrasion, or high resistance to high temperatures.

In the prior art there are several known types of housings of electrical plug connector, preferably made with various types of material, either metallic or insulating. Metallic materials offer the advantage of being mechanically more robust and to provide electrical connectors placed inside them, thanks to the electrical conductivity of the housing, protection against electromagnetic interference.

It is, however, a relevant disadvantage to many metal housings of electrical plug connectors that their surface corrodes and that, as a result of said corrosion, the technical functionality of the plug connector can be compromised due to the progressive loss of surface layers of the material of the housings, with impairment of the degree of protection.

Even if the functional impairment is not reached, it is always important the need to maintain the integrity of the aesthetic appearance.

In the prior art there are various methods to protect from corrosion the surface of a metal housing of an electrical plug connector. A typical form is a powder coating made with suitable thermosetting powder paint polymer matrix (e.g. polyester, epoxy, or a combination of the two). Particularly for heavy-duty multipole electrical connectors of industrial type it is usual in the prior art that the surface of the metal housings, typically made of die-cast aluminium, is protected with a protective coating, on the one hand to achieve the protection against corrosion, on the other hand to obtain a pleasant aesthetic appearance.

In particular in the housings of heavy-duty electrical plug connectors of industrial type, which also feature a locking device, e.g. of the type with snap-latching hook-shaped locking levers (e.g. with snap-latching hook-shaped levers of the type described by EP 0352579 A1 (ILME), or by DE 20 2004 004 619 U1 (ILME)), or with screws or with pins ending with a bayonet, it happens that different metallic materials (dissimilar) come, either directly or indirectly, into mutual contact. Thus e.g. the locking device with snap-latching locking levers may consist of hooks made of stainless steel, whereas the actual plug connector housing is made of aluminium alloy or zinc alloy for die-casting. Other combinations of materials occur in practice depending on the uses. In presence of conductive atmosphere, e.g. due to moisture condensation or by stagnation of water and of an electrolyte on the surfaces of said housing, for example sodium chloride deriving from the brackish atmosphere in a coastal area, this leads to the problem of contact corrosion between the more noble metal and the base metal, less noble, due to the appearance of a standard electrochemical potential difference between the less noble base metal (e.g.

aluminium alloy) and the one of the locking levers (e.g. stainless steel). It is well documented in the technical literature what the consequences of the contact of base materials with different standard potentials are. The higher the difference in electrochemical potential, that is as far from each other the metals in contact are in the series of the electrochemical potentials (see, for example, the table of IEC 60950-1, Annex J), the higher the effects of corrosion.

Same in the prior art are known protective coatings and surface modifications that determine a beneficial change in the electrochemical potential standards, such as nickel plating, or hard chrome plating, or conversion coating (chromating) with yellow chromate. These coatings exhibit a complex behaviour in combination with base metals. The self-formed modified electrochemical potential is also dependent on the layers formed therein. By means of conventional measuring methods, such as for example the curves “current density—potential” (Evans charts) with a suitable electrolyte, one can determine the corresponding standard electrochemical potential. A plug connector housing of the type object of the present invention is designed and constructed to protect from the effects of the external environment the contact elements installed inside said housing. The housing normally includes at least one opening through which a cable to be enclosed can enter, wherein the individual conductors of said cable are brought into contact with the corresponding contact elements of a multipole electric plug connector insert. In general, these elementary conductors are used for transmission of electric current (power supply), for powering the electrical devices of the circuits downstream of the electrical plug connector. In the same housing, depending on the type of plug connector element installed within, more than one way in parallel may be also provided, of a type different from electrical, e.g. conduction lines for pneumatic transmission and/or conductors for fibre optic contacts, for transmitting optical signals.

The main task of a plug connector housing is essentially the protection from external influences of contact inserts and of the relevant electric, pneumatic or fibre optic contacts, disposed within said connector housing, also ensuring the protection of persons (users) from the so-called direct contact, thus from the risk of electrocution (electric shock). Since these are essential protective measures, a high degree of reliability is required for the plug connector housing.

Plug connector housings, particularly those of the metallic type, suitably selected, are often used in applications in which the connectors are subject to high mechanical influences, e.g. vibration, shock, acceleration, as well as to severe environmental conditions, such as e.g. extreme temperatures, precipitation, wind, solar radiation, salty air, chemical pollution, etc.

On the market there is always obvious attention to the more economically attractive technical solutions, but care should be taken so that, for the plug connector housing, the economy does not come at the expense of the growing need for safety and reliability of the protection. To a favourable initial investment, it often follows a huge cost of maintenance for the full replacement of the connector housings, prematurely damaged by harsh environmental working conditions.

In this regard the prior art already provides for the use of various types of protective coating applied to the plug connector housing; the use of stainless steel is then one of the most common measures to achieve enhanced protection to corrosion, but this makes the plug connector housing significantly more expensive, as well as such that it can be manufactured only at high cost.

A significant problem that occurs in practice, particularly in the field of application of aggressive atmospheres, is the corrosion of said plug connectors metal housings, as described above, particularly the contact corrosion due to different electrochemical potential between the dissimilar metals put into contact between them.

Even in the case of use of die-cast aluminium alloys, plug connector housings are regularly subjected to galvanic corrosion. When using thermosetting polymeric protective coatings, for example of the powder type previously described, filiform corrosion and/or corrosion from migrating under said protective coatings adds up, particularly under the layers of applied protective paint. Such corrosion represents initially a cosmetic defect but, over time, it can result in loss of the degree of protection provided by enclosures.

A common practice for the application of a top protective layer which has primarily aesthetic functions, foresees the preventive application of a passivation, with the relevant activation of the surface, to enhance the adhesion and improve the performance of the subsequent application of said protective layer. Such additional or intermediates passivation layers are expensive, but necessary to improve on the one hand the coating and its adherence and on the other to prepare for the next painting operation.

Said passivation processes open the field to other problems caused by legislative provisions regarding the preservation of the ecosystem: the chromate and pre-treatments based on hexavalent chromium are banned on the market, as a result of the European Union RoHS (restriction of hazardous substances) Directive, with similar regional regulations in force in China, the US and, for example, in the naval sector (IMO), and since time they can no longer be used.

This has resulted in particular problems in the standardized processes of painting, in which it occurred either to remove or to modify said pre-treatments, as no longer permitted. The alternatives hitherto become available on the market, such as for example chromate conversion treatments based on trivalent chromium, or fluoride-zirconium, have not been able to guarantee the same results or better, in terms of performance of resistance to corrosion, the obsolete treatment of chromic conversion based on hexavalent chromium.

Further problems arise from the increasing application of heavy-duty plug connector housings for industrial type applications in the context of railway rolling stock, for example for connections between rail vehicles or for electrical connections under the car body or on the bogies of the same rail wagons between different pieces of the electric traction equipment, for an easier maintainability by replacement, with reduction of technical downtime of the rolling stock material. In these fields of application, where the electrical plug connector housing couplings are frequently exposed to the external environment, the corrosive effects of the coastal and/or industrial atmospheres crossed by the rolling stock, will add up to those of abrasion of the protective coating of the electric plug connector housing by effect of micro/macro shocks that are determined, on said housings, as a result of flying stones, foreign objects and powder from the roadbed [standing seat of the tracks], the projection being amplified by the speed of the rail vehicles themselves, that the railway technology tends progressively to increase, in general for all types of rail vehicles and in particular for high-speed trains.

It is necessary to confer to the protective outer coating of said plug connector housings a particular resistance to impact and to the ablation effects, being simulated, for example, by the methods of ISO 20567-1 (impact testing by stone-chips) and IEC 60068-2 -68 (sandblasting test).

The points of impact of sand and stones into the housings of the plug connector of the metallic type more commonly known in the art, including those for heavy-duty industrial applications, in which there is only a protective coating by means of powder coating (e.g. epoxy, although with good resistance to abrasion) may in certain cases reach the base metal of said housing and such breakage of the protective coating may act as starting point for under-film [scab] corrosion.

Heavy-duty plug connector housings described in DE 102012102275.5 (Harting) have been recently introduced in the prior art, presenting an outer coating made of polymer material based on polyurethane, moulded over a plug connector metal frame (housing) made for example of die-cast aluminium alloy. Said housings offer resistance to the aforementioned mechanical impacts, good chemical resistance, excellent resistance to saline corrosion, but suffer however of reduced resistance to the temperatures typical of multipole electrical plug connectors of the industrial type, normally suitable for operation in the temperature range between −40° C. and +125° C. The polymeric materials used, having to provide at the same time a wide range of fire resistance performance, toxicity and smoke opacity (i.e. those fixed by the standard EN 45545-2), which are not required, as not applicable, to the metal plug connector housings, are expensive and in any case they limit—for the particular technology used (RIM=Reaction Injection Moulding)−the maximum temperature of use of said plug connector housings, and therefore of the relevant plug connector inserts installed within them, to +85° C. The particular technology adopted also requires the realization of new dedicated equipment (moulds) for the overmoulding of polyurethane rubber, thus resulting extremely expensive and limiting the possibilities of supply, not enabling to reuse of any of the electrical plug connector housing parts already available. In the transition points (cable outlets, fixing screws through-holes) special noble metal (e.g. stainless steel) threaded bushes supplied separately, are also required to be installed by the user, all with an increase of the overall cost of the product for the user.

### SUMMARY OF THE INVENTION

The object of the present invention is to provide an electrical plug connector housing, in particular equipped with locking devices, in which the material of the plug connector housing consists preferably of aluminium and the material of the locking device consists preferably of stainless steel, with increased protection against corrosion, being provided with a corrosion-proof protective coating which increases significantly the resistance to corrosion.

A further object of the present invention is to provide such a plug connector housing which provides also a remarkable resistance to impact with stones and to abrasion by sand blasting, by virtue of surface hardness and of adhesion and abrasion resistance of the particular protective coating, without compromising the temperature range of typical use of said connectors.

A further object of the present invention is to enable the plug connector housing to be usefully equipped with sealing gaskets made of elastomeric materials specially selected to withstand both the cold (low ambient temperature) that the hot (high ambient temperature) such as, for example, silicone. The combination with said anti-corrosion protective coating, particularly resistant to high temperatures, enables the realization of plug connector housings which, besides being extremely resistant to corrosion, well beyond the resistance values achieved so far by heavy-duty industrial plug connector housings, already indicated for aggressive environments, of the known technique, are also resistant to both low and high temperatures, as well as resistant to shocks from stones and abrasion by sandblasting, essential factor when the phenomenon is combined with the presence of corrosive atmospheres.

A further object of the present invention is to provide a plug connector housing economic [cheap] in relation to the increase of resistance to corrosion, resistance to high and low temperatures, mechanical resistance to impact and abrasion achieved, in relation to the increase of life, thus of operating free from necessity of periodic replacement, as achieved when subjected to any of the environmental stresses described above, because of the virtual non-necessity of periodic replacement for deterioration of the aesthetic appearance, and that does not have all the disadvantages of the products of the known art previously described.

In particular, it aims to provide a heavy-duty plug connector housing for industrial environments, both indoors and outdoors, or for example in the railway field for outdoor use and/or in marine environments, both coastal (on-shore) than in the open sea (ships, off-shore platforms) for use outside, which—also in case of use of dissimilar materials—do not manifest any sign of corrosion or posters negligible corrosion marks only after extremely prolonged exposures to the corrosive atmosphere and to the atmospheric phenomena typical of these environments.

Further fundamental object of the present invention is to provide a plug connector housing virtually realizable without specific dedicated equipment in all the combinations of mounting configurations for the standard (normal) configurations currently available on the market that, for each constructional size, further differentiate on the basis of: (a) size (thread), number and position of the cable output/s (horizontal, vertical, frontal), (b) type of locking lever device (e.g. with snap-latching locking levers of the types previously described, or with screw locking or by bayonet tipped pins), (c) type of sealing, which depends on maintaining the highest IP degree of protection according to EN 60529 in the various conditions of use, e.g. in relation to the need for increased resistance to chemical and/or extreme temperatures, both high and low.

These and other objects are achieved by the electrical plug connector housing according to the invention which has the characteristics of the annexed independent claim 1.

Advantageous embodiments of the invention are apparent from the dependent claims. Basically, the plug connector housing according to the invention is composed of two parts, each comprising a respective metallic shell preferably made of aluminium alloy, suitable for housing at least one respective contact element connectable to a conductor of a cable, comprising at least a locking device and at least one sealing gasket made of elastomeric material, said metal shell comprising a protective coating resistant to corrosion and erosion at least over its outer surface, wherein said protective coating resistant to corrosion and erosion is made from at least one electrolytic ceramic coating.

The present invention solves the problem posed by identifying a specific and innovative combination of materials and subsequent protective coatings, especially optimized for the plug connector housing of the type described.

### BRIEF DESCRIPTION OF THE DRAWINGS

Further characteristics of the invention will become clearer from the detailed description that follows, referring to merely exemplary, and therefore non-limiting embodiments, illustrated in the appended drawings, in which:

FIG. 1 shows, in axonometric view, a closed coupling of housings, of the type object of the present invention, the fixed housing being in particular provided with at least one lever-type locking element with snap-latching and the free housing [hood] with corresponding at least two locking pins for the corresponding [locking] lever;

FIG. 2 shows, in axonometric view, the coupling of FIG. 1 opened, to highlight the contact-holding inserts—respectively female and male plug connector inserts—accommodated in said housings, and further details of the described example;

FIG. 3 shows, in axonometric view, the free housing [hood] of FIG. 1 appropriately cross-sectioned and with relevant detail of the protective coating;

FIG. 4 shows, in an axonometric view, an alternate embodiment of the free housing [hood] of FIG. 1, suitably cross-sectioned and with relevant detail of the protective coating. Particularly in this embodiment said protective coating is devoid of the outer final coating which is present in the example of FIG. 3;

FIG. 5 shows, in an axonometric view, an alternate embodiment of the coupling of housings of FIG. 1, juxtaposed and in open position, in particular equipped with screw-locking elements (screws and respective nuts) and with O-ring type sealing gaskets, placed in special seats both along the inner perimeter of the bottom or flange face (not visible) of the fixed housing part, and near the upper interface edge of said fixed housing;

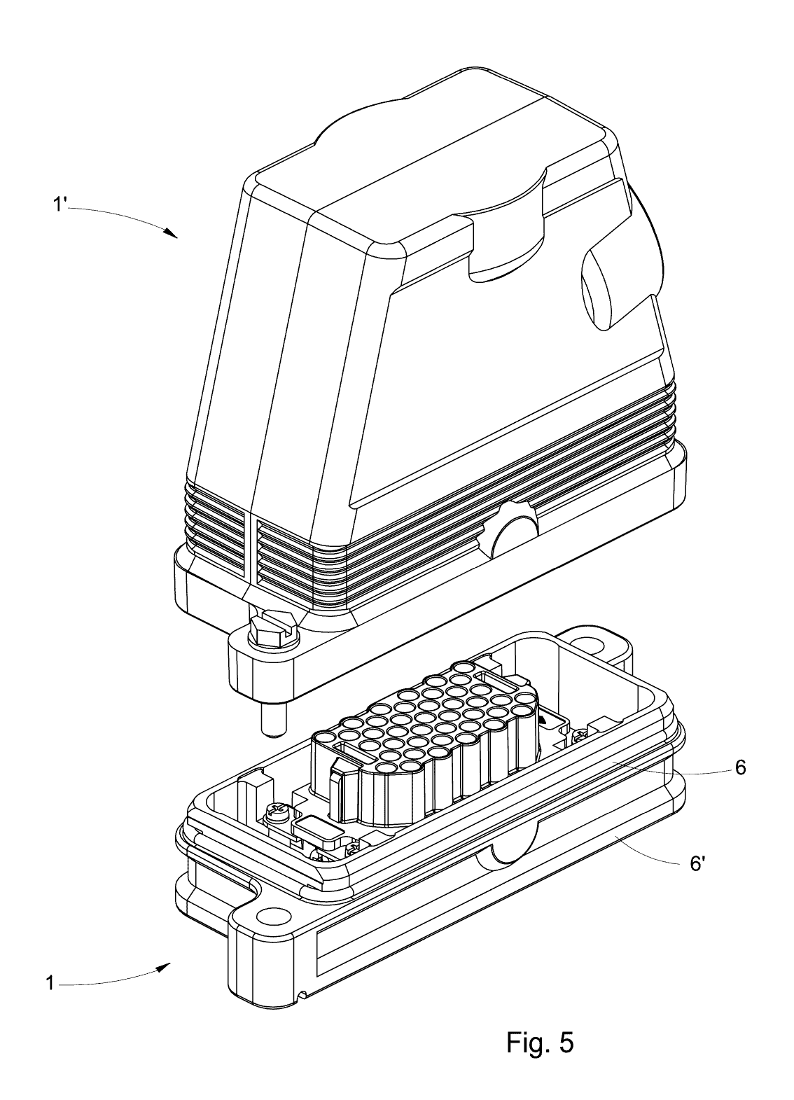

FIG. 6 shows in an axonometric view a further alternative embodiment of the fixed housing of FIG. 1, fitted with the respective connector insert, but equipped, alternatively, of a different type of locking lever with snap-latching, in particular of the type described in DE 20 2004 004 619 U1;

### DETAIL DESCRIPTION OF THE INVENTION

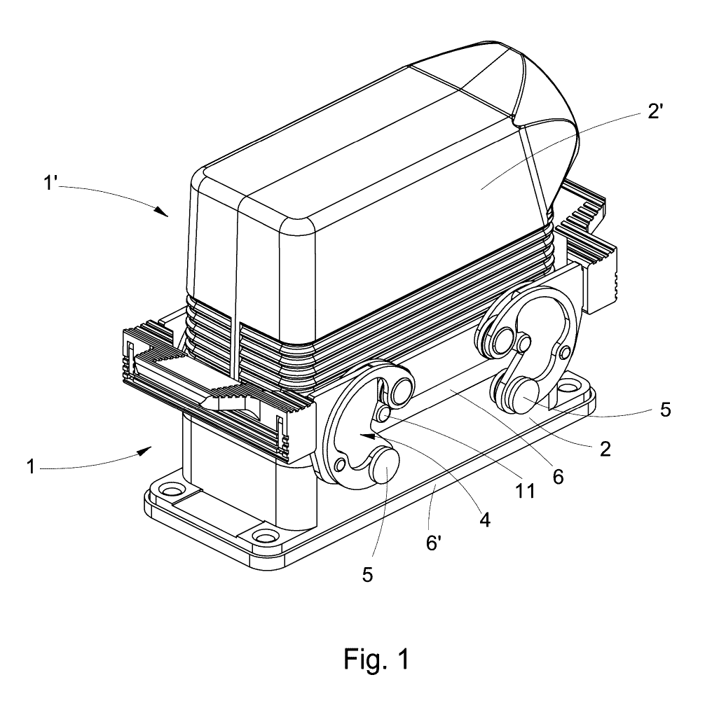

With reference to FIG. 1, said coupling includes two housings 1, 1′, respectively fixed 1 and free 1′; couplings between both free or fixed housings, although less frequent, are however possible. Said two housings are made of the same materials.

The description of the fixed housing 1, for technical equivalents, applies therefore also to the free one 1′. Each part of housings coupling—fixed 1, free 1′—comprises a metal shell 2, 2′, in particular made of die-cast aluminium alloy.

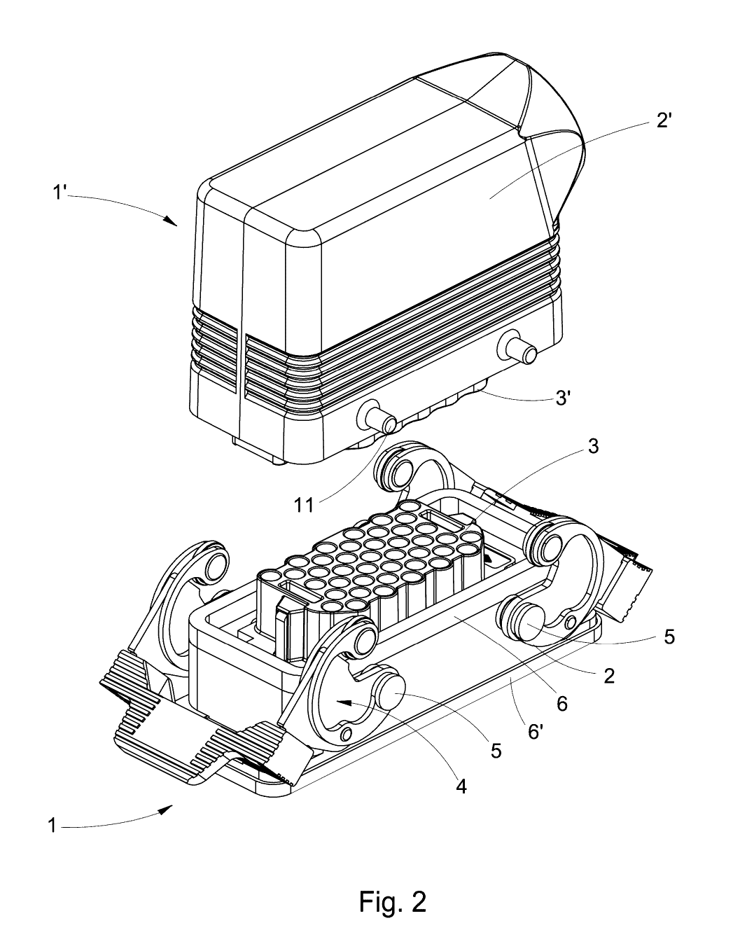

With reference to FIG. 2, in the fixed housing 1 a contact-holding insert (connector insert) of the socket-outlet type 3, with female contacts is typically housed, whereas in the corresponding free housing 1′ a contact-holding insert (connector insert) of the plug type 3′, with male contacts is housed. Couplings between housings in which the positions of contact-holding inserts of male and female type are reversed, although less frequent, are still possible. The fixed plug connector housing 1 is provided with at least a locking device 4 in the proximity of the outlet opening of the housing itself, for example of the locking lever type with snap-latching described in EP 0352579 A1, consisting of movable parts made of a metal different from that constituting the shell 2 of the housing, for example of stainless steel, and fixed by means of hinging pins 5, riveted or screwed in the side walls of the shell 2 of the fixed housing 1, said pins 5 being also made of stainless steel. The tightness to dust and liquids (degree of protection IP65 or higher according to EN 60529) is ensured by interface 6 and flange 6′ sealing gaskets, made of a suitable elastomeric material according to the temperature range of employment and the expected environmental conditions. In the preferred embodiment described herein, without limitation to further variants, said sealing gaskets are made with fluorinated elastomer (FKM or FFKM, FPM or FEPM according to ASTM D 1418 or ISO 1629), for example of the type commercially known as Viton®.

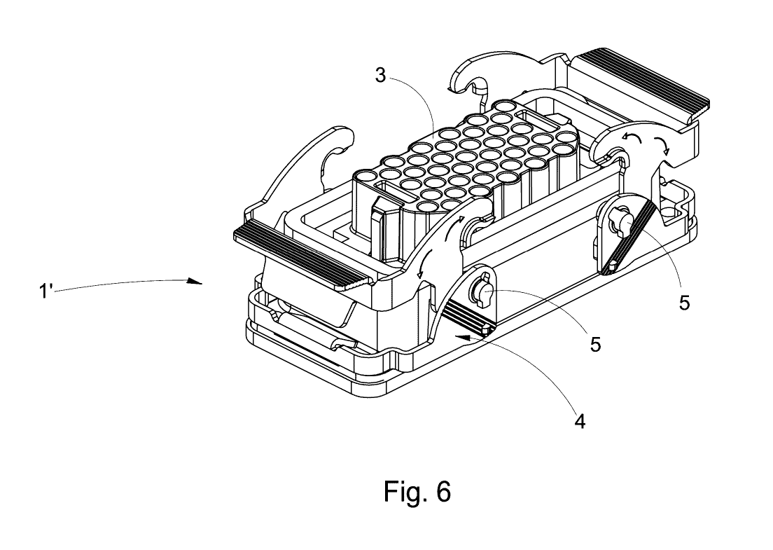

With reference to FIG. 6, in an alternative embodiment with snap-latching locking lever of the type described in DE 202004004619 U1 the hinging pins of the levers 5 may be formed integrally to the housing, thus by die-casting, and thus also be of die-cast aluminium alloy and, in turn, provided with the protective coating described in the following.

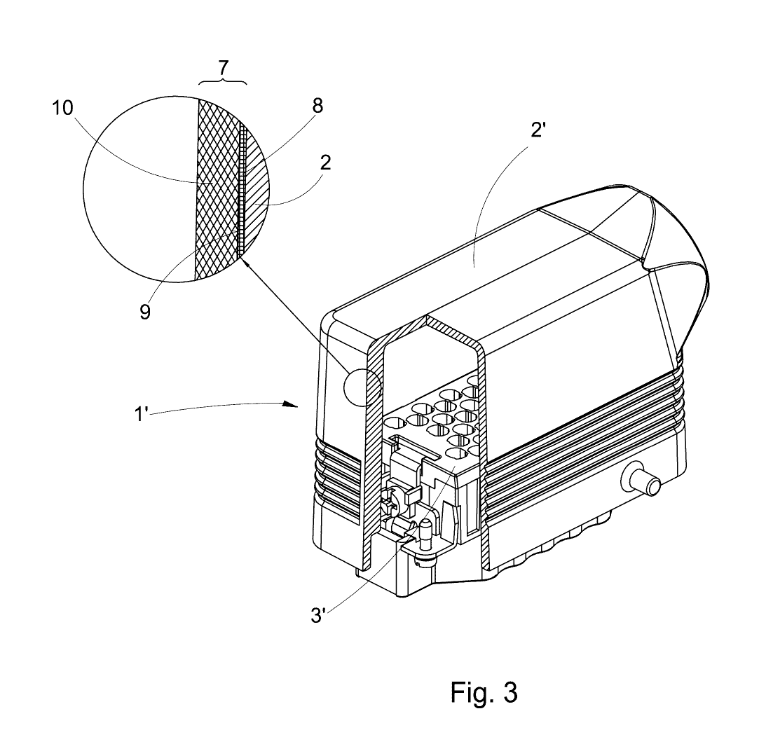

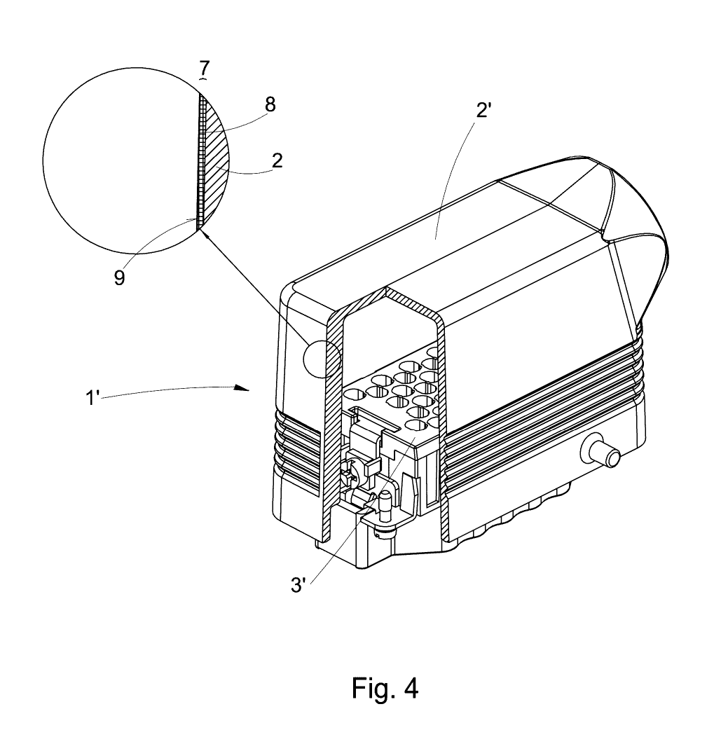

With reference to FIG. 3, and—as applicable—to FIG. 4, the metal shell of die-cast aluminium 2′ of the free housing 1′ is subjected to a treatment, consisting for example of a sandblasting cycle, as adhesion promoter of a subsequent protective coating resistant to corrosion and erosion 7. Said metallic shell 2′ is coated, after suitable further cleaning treatment of the surfaces—consisting for example, by a cycle with alkaline degreasing, followed by rinsing, from subsequent acid attack by pickling, final rinsing and drying—by a first protective layer 8, constituted by a ceramic coating of titanium oxide, uniformly distributed, and obtained by electrolytic deposition, of substantially uniform thickness which, for the process and materials used, may typically vary from 2 μm and 15 μm but that, for the housing of the present invention, has been optimized in the range between 10 μm and 15 μm. Said first protective layer 8 is characterized by high surface hardness, combined with an excellent flexibility (resistance to bending and drawing of any subsequent processing of the coated artifacts), excellent resistance to friction wear, excellent resistance to atmospheric and marine corrosion, excellent resistance to heat, absence of heavy or toxic metals (such as chromium).

A drawback of said ceramic coating, despite the considerable mechanical properties described above and the tenacious adhesion to the base metal, is the limited resistance to abrasion by rubbing or by projection of sand or stones. Said deposit being relatively thin (between 10 μm and 12 μm) for the parts of the housing subject to wear, such as the locking pegs 11 of the locking levers of the housings, or—with reference to FIG. 6—the hinging pins 5 of the levers themselves, the realization—where possible—as added parts of stainless steel (pins and hinging pins applied on the die-cast housings and secured by riveting or screwing) is preferable, despite the contact between dissimilar metals (stainless steel and aluminium) is not among the most favourable.

A further drawback of said ceramic coating of titanium oxide emerged in a first series of experimental corrosion tests in neutral salt spray (test according to UNI EN ISO 9227) is a degree, albeit contained, of residual porosity of said coating, put into evidence from occasional surfacing of red spots that proved to be iron oxide, emerged from the matrix of the shell of die-cast aluminium alloy below said coating.

For the purpose of (a) filling the residual porosity of said ceramic protective coating and (b) providing promotion of the adhesion of a possible further final outer protective coating, said ceramic protective coating is further coated, by chemical or electrolytic way, by a thin coating of organic sealant 9, transparent, based on organic polymers in aqueous solution, in particular based on acrylic resin or alkyd resin, having a thickness between 500 nm and 1000 nm.

With reference to the detail of FIG. 3, in order to impart to the outer surfaces of the housing the best resistance to abrasion by projection of sand or stones, the organic sealant coating is then covered with a final outer coating 10, obtained with a cycle of electrostatic painting with powder of thermosetting polymers, in the example described here, without limitation to other types, epoxy-type, having a thickness between 60 μm and 120 μm, further having additional barrier effect to the contact with chemically aggressive substances for the underlying base metal, and decorative effect.

With reference to the detail of FIG. 4, said coating of organic sealant 9, being by itself resistant to washing with the typical acid and alkali detergents used in industry, makes optional the final thermosetting outer coating 10 described in the example of FIG. 3 that, normally transparent, it is instead coloured with a suitable pigmentation, to give the coating itself, in this case the final one, a different colour than the typical dark grey colour of the underlying first protective layer 8 made of a ceramic coating of oxide titanium. In the invention's embodiment of FIG. 4 the final outer coating 10 of FIG. 3, limited to the temperature of 125° C., is therefore omitted, for not limiting its resistance to high temperatures that, particularly in combination with silicone sealing gaskets can therefore reach the temperature application limit of 180° C. of the special contact-holding inserts (connector inserts) for high temperatures available in the known art.

Several tests of accelerated corrosion in neutral salt spray conducted on various prototypes according to the UNI EN ISO 9227 standard have highlighted the increase of resistance to saline corrosion according to the summary table of Table 1 reported below, with reference to the existing ILME products of the series W (housings for harsh environments) of the prior art.

The plug connector housings of the present invention have shown ability to resist corrosion, without the occurrence of any significant aesthetic defect, for a duration of up to 6 times that of the best products of the prior art hitherto available, the latter being able to overcome a corrosion test of 400 h. The tests have also indicated the essentiality of the coating of organic sealant 9 in combination with the electrolytic ceramic coating 8: if the latter with respect to the reference triples the corrosion resistance, the further presence of coating of organic sealant 9 leads to double this increase, achieving resistance up to 6 times that of the reference.

TABLE 1
Results of tests on cases of connector ILME

| | | | Series E (1) | Series ET (1) | Series E (2) | Series ET (2) |
|---|---|---|---|---|---|---|
| | | | without | without | with | with |
| | | | sealant (9) | sealant (9) | sealant (9) | sealant (9) |
| | Series W | Series W | with final | without final | with final | without final |
| Characteristics | current | evolution | coating (10) | coating (10) | coating (10) | coating (10) |
| Thermal resistance | −40° C./ | −40° C./ | −40° C./ | −40° C./ | −40° C./ | −60° C./ |
| | +125° C. | +125° C. | +125° C. | +180° C. | +125° C. | +180° C. |
| Chemical resistance | medium-high | medium-high | high | high | high | high |
| Mechanical strength | low | medium | high | medium-high | high | medium-high |
| Blasting EN 60068-2-68 | | | | | | |
| Impact of stones ISO 20567-1 | | | | | | |
| Neutral salt spray | reference | 2x reference | 3x reference | 2x reference | 6x reference | 5x reference |
| UNI EN ISO 9227:2012 | | | | | | |

Of course the invention is not limited to the particular embodiments previously described and illustrated in the appended drawings, but it can be subject to numerous modifications of detail within the reach of the skilled in the art, without departing from the scope of the invention defined by the appended claims.

1. Plug connector housing composed of two parts (1, 1′), each comprising a respective metal shell (2, 2′) preferably made of aluminum alloy, suitable for housing at least one respective contact element (3, 3′) connectable to a conductor of a cable, comprising at least one locking device (4) and at least one sealing gasket (6, 6′) of elastomeric material, said metal shell (2, 2′) comprising a protective coating resistant to corrosion and erosion (7) at least along its outer surface, said protective coating resistant to corrosion and erosion (7) being constituted by at least one electrolytic ceramic coating (8), wherein said electrolytic ceramic coating (8) is covered with a further coating of organic sealant (9), wherein said coating of organic sealant (9) is covered by a further outer coating finish (10) and said outer coating finish is made by thermosetting resin.

2. Plug connector housing according to claim 1 wherein the electrolytic ceramic coating (8) of the protective coating resistant to corrosion and erosion (7) comprises a titanium ceramic (titanium oxide).

3. Plug connector housing according to claim 1 wherein the electrolytic ceramic coating (8) of the protective coating resistant to corrosion and erosion (7) has a thickness between 10 μm and 12 μm.

4. Plug connector housing according to claim 1, wherein said coating of organic sealant (9) is composed of acrylic or alkyd resin.

5. Plug connector housing according to claim 1, wherein said coating of organic sealant (9) has a thickness between 500 nm and 1000 nm.

6. Plug connector housing according to claim 1, wherein said outer coating finish (10) has a thickness between 60 mμ and 120 μm.

7. Plug connector housing according to claim 1, wherein the electrolytic ceramic coating (8) of the protective coating resistant to corrosion and erosion (7) is applied using a Alodine® EC2™ process.

8. Plug connector housing according to claim 1 wherein said at least one seal (6, 6′) is made from fluorinated elastomers, or from silicone-based elastomer, or from elastomer based on nitrile rubber (NBR), or from elastomer based of hydrogenated nitrile rubber (HNBR).

9. Plug connector housing according to claim 2 wherein the electrolytic ceramic coating (8) of the protective coating resistant to corrosion and erosion (7) has a thickness between 10 μm and 12 μm.
